(19) United States
(12) Patent Application Publication
(10) Pub. No.: US 2017/0144582 A1
(43) Pub. Date: May 25, 2017

(54) Bracket and Tie-Down Ring Assembly for Replacement, Repair, and New Builds

(71) Applicant: Sunrez Inc., El Cajon, CA (US)

(72) Inventors: Mark Livesay, El Cajon, CA (US); Bret Tollgaard, El Cajon, CA (US)

(21) Appl. No.: 15/357,803

(22) Filed: Nov. 21, 2016

Related U.S. Application Data
(60) Provisional application No. 62/257,700, filed on Nov. 19, 2015.

(51) Int. Cl. B60P 7/08; B63B 25/28; F16M 13/02; B61D 45/00

(52) U.S. Cl. CPC B60P 7/0807; B61D 45/001; B63B 25/28; F16M 13/02

(57) ABSTRACT

A cargo restraint system having a load bearing perimeter rail and a tie-down ring assembly. The load bearing perimeter rail further comprised of a plurality of protruding bosses with a hole within each boss. Further, a tie-down ring assembly comprised of a tie-down ring and a pin wherein the tie-down ring is inserted through the hole in the plurality of protruding bosses of the load bearing perimeter rail. Further still a method providing a cargo restraint assembly wherein the cargo restraint assembly comprises a load bearing bracket and a tie-down ring assembly, and further wherein the tie down ring assembly is capable of being altered to adapt different size brackets, tie-down rings, pins, mechanical fasteners, and adhesives for different load scenarios.

### RELATED APPLICATIONS

This application is a non-provisional application claiming the benefit of priority from U.S. Provisional Application No. 62/257,700 filed Nov. 19, 2015, the entire contents of which is herein incorporated.

### BACKGROUND OF THE INVENTION

The present invention is in the technical field of load bearing hardware. More particularly, the present invention is in the technical field of restraint systems. More particularly still, the present invention is in the technical field of rail and hardware integration methods.

Conventional air cargo pallets consist of an outer rail which runs along the perimeter of a sandwich panel core. The outer rail has holes which provide attachment points for a tie-down ring and bracket assembly that connects to the outer rail by one time use fasteners. The fasteners are difficult to remove when replacing the tie-down ring and bracket assembly. Additionally, because the tie-down ring and bracket assembly is a fixed assembly, when either the tie-down ring or the bracket is damaged, both must be replaced, increasing the cost of repair.

Conventional 463L air cargo pallet ring assemblies are attached to an extruded outer rail of the pallet via three blind rivet mechanical fasteners. Analysis shows that over 60% of pallets being repaired need their rings addressed due to the ineffective design and fastening of the current system. Currently, repairs are only performed after shipping pallets from the location of damage back to a repair depot facility in the United States. The attachment method and geometry of the bracket and ring assembly combined lend themselves to premature failure. Additionally, replacement of damaged rings requires the removal and replacement of the entire bracket assembly, not just the damaged ring, causing more time and cost spent on repairs. Inadequate mechanical design, material selection, fastening method, and corrosion resistance of the current bracket and tie-down ring assembly leads to more frequent repairs, more down time of pallets, and more overall cost.

### SUMMARY OF THE INVENTION

It is an object of the present invention to provide a tie-down ring and bracket assembly wherein the bracket is mounted with mechanical fasteners and/or adhesive to a perimeter rail.

It is another object of the present invention to provide a tie-down ring and bracket assembly wherein the tie-down ring is removable and replaceable.

It is another object of the present invention to provide a tie-down ring and bracket assembly wherein the bracket is removable and replaceable.

It is yet another object of the present invention to provide a tie-down ring and bracket assembly that effectively transfers a load through the tie-down ring and bracket assembly to the perimeter rail.

It is still another object of the present invention to provide a tie-down ring and bracket assembly which exceeds all physical load requirements in the 463L material handling system.

It is a further object of the present invention to provide a tie-down ring and bracket assembly that resists failure under rapid acceleration or deceleration conditions resulting in high instantaneous loads.

It is a further object of the present invention to provide a method for replacing and repairing a tie-down ring and bracket assembly on a pallet system required to secure heavy loads on the pallet and will undergo rapid acceleration or deceleration generating high instantaneous loads on the tie-down ring and bracket assembly.

It is another object of the present invention to provide a method of restraining cargo, the method providing a cargo restraint assembly wherein the cargo restraint assembly comprises a load bearing bracket and a tie-down ring assembly, and further wherein the tie down ring assembly is capable of being altered to adapt different size brackets, tie-down rings, pins, mechanical fasteners, and adhesives for different load scenarios.

It is yet another object of the present invention to provide a load bearing restraint assembly for truck beds, rail cars, cargo systems, boats, manufacturing plants, industry buildings, architecture, off road vehicles, military vehicles, emergency response vehicles, anything that warrants load bearing hardware being utilized to constrain a load through means of a tie-down ring.

### BRIEF DESCRIPTION OF THE DRAWINGS

FIG. 1 is a perspective view of the bracket of the present invention used to attach the load bearing cargo ring to the outer rail of a 463L pallet;

FIG. 2 is a side view of the bracket of the present invention used to attach the load bearing cargo ring to the outer rail of a 463L pallet;

FIG. 3 is a front view of the bracket of the present invention used to attach the load bearing cargo ring to the outer rail of a 463L pallet;

FIG. 4 is a front view of the bracket of the present invention equipped with the load bearing tie-down ring of the present invention and attachment hardware;

FIG. 5 is a perspective view of the bracket of the present invention equipped with the load bearing tie-down ring of the present invention and attachment hardware;

FIG. 6a is a side view of the assembled bracket and ring sub-assembly of the present invention attached to a representational segment of a 463L air cargo pallet perimeter rail in the unloaded configuration and FIG. 6b in the loaded ring configuration;

FIG. 7 is a front view of the assembled bracket and ring sub-assembly of the present invention attached to a representational segment of a 463L air cargo pallet perimeter rail; and

FIG. 8 is a perspective view of the assembled bracket and ring sub-assembly of the present invention attached to a representational segment of a 463L air cargo pallet perimeter rail.

FIG. 9 shows the results of a 90° ring load test comparing the Legacy restraint system and the restrain system of the present invention.

FIG. 10 shows the results of a 180° ring load test comparing the Legacy restraint system and the restraint system of the present invention.

FIG. 11 shows the results of a ring maximum load test comparing the Legacy restrain system and the restraint system of the present invention at various degrees.

### DETAILED DESCRIPTION OF THE INVENTION

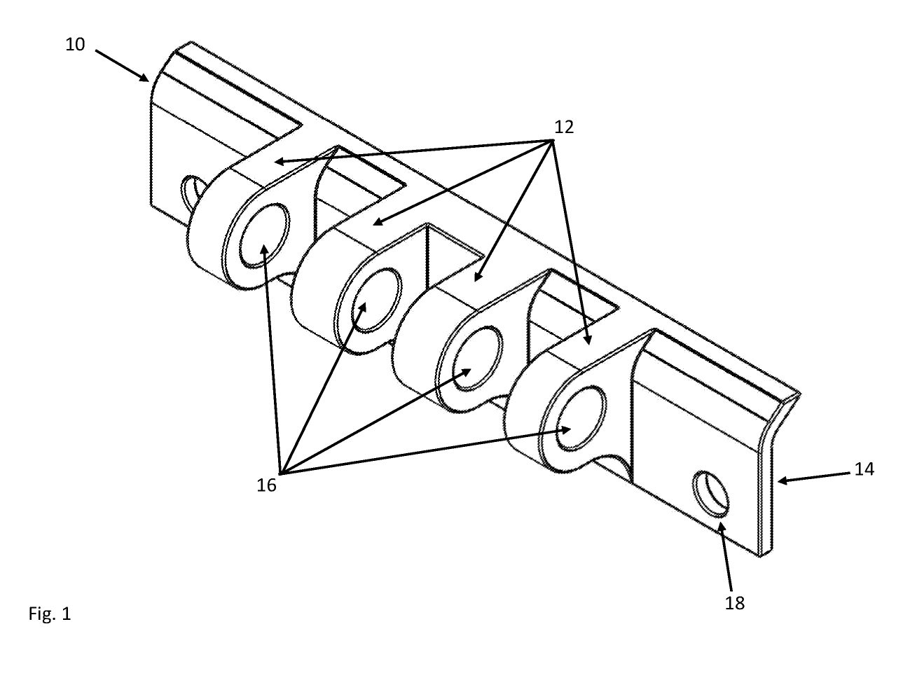

Referring now to the invention in more detail, FIG. 1 depicts a bracket 10 with a plurality of protruding bosses 12 which are integral to bracket 10 and extend perpendicularly from bracket 10. The plurality of bosses 12 have holes 16 which extend completely through each boss 12. Bracket 10 also has through holes 18 which allow mechanical fasteners to attach bracket 10 to a perimeter rail which is in contact with face 14. Face 14 is contoured such that the perimeter rail and face 14 have parallel, adjacent contacting surfaces.

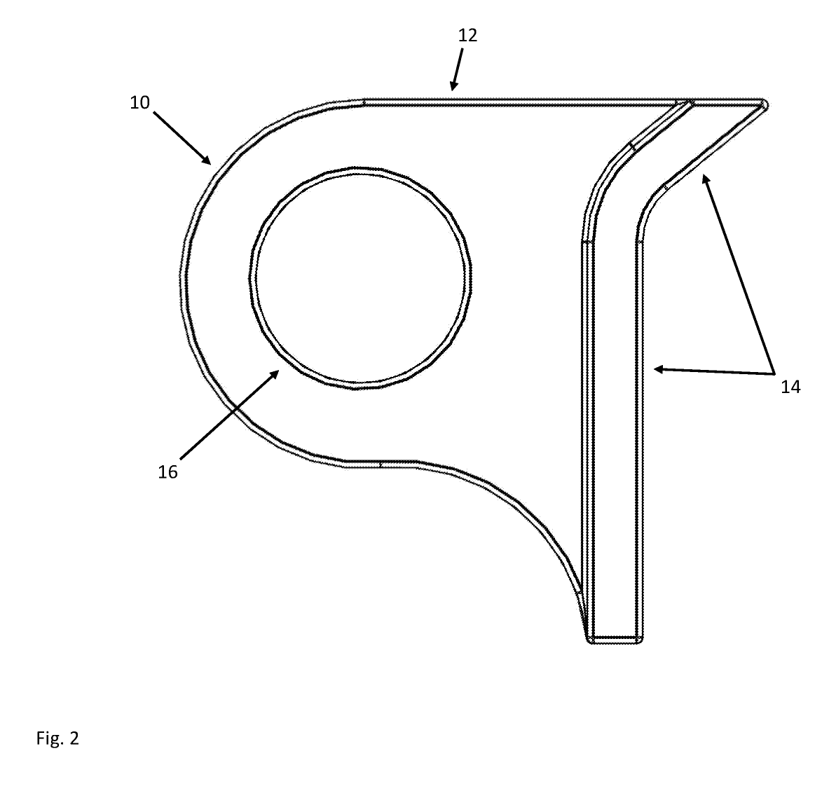

In further detail, referring to the invention of FIG. 2, bracket 10 is shaped such that its thickness and contours are sufficient at distributing the necessary loads it will encounter. Bracket 10 is roughly 5″ in length and 1″ tall so that face 14 has adequate surface area for bonding to a perimeter rail. The plurality of protruding bosses 12 extend from the top to the bottom of bracket 10 and the furthest point latitudinally from the curved end of bosses 12 to the back of face 14 of bracket 10 is 1.1 inches. Hole 16 is approx. 0.4 inches in diameter whereas face hole 18 (as seen in FIG. 1) has a diameter ranging from 0.2-0.4 inches and is spaced such that mechanical fasteners can be appropriately installed.

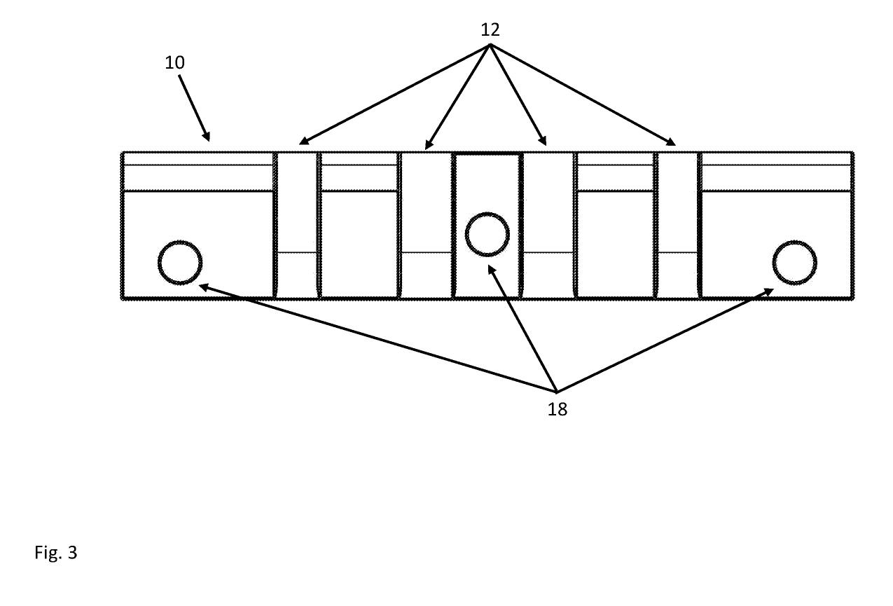

Referring to the invention of FIG. 3, bracket 10 includes integral bosses 12 which extend perpendicularly from bracket 10 and are designed to withstand loads transferred to them by load bearing hardware (not shown) which fits between bosses 12 at hole 16 (as shown in FIG. 1 and FIG. 2). Hole 16 in boss 12 is designed to accommodate a pin or bolt which allows load bearing hardware to rotate 180° about hole 16. Face holes 18 in bracket 10 are used to help transfer the load from bracket 10 into a perimeter rail.

Still referring to FIG. 1-3, bracket 10 may be constructed of heat treated steel or any other sufficiently rigid and strong material such as metals, composites, or plastics. Bracket 10 may be constructed in ways such as forging, machining, casting, 3D printing, and any other method in which a sufficiently strong bracket 10 can be made. Protruding bosses 12 are integral members of bracket 10 and are therefore constructed of the same material. Hole 16 and face hole 18 represent the absence of said material of bracket 10.

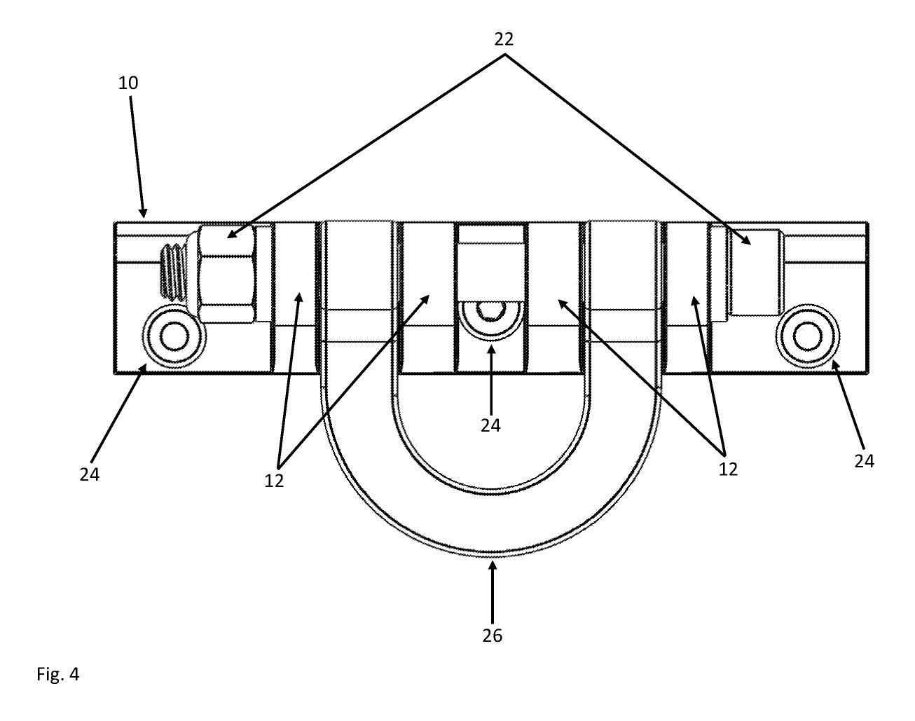

Referring now to the invention shown in FIG. 4, bracket 10 has been equipped with ring attachment hardware 22 through hole 16 (not shown) and bracket attachment hardware 24 through face hole 18 (not shown). Also shown is a load bearing tie-down ring 26 which sits in between protruding bosses 12 between ring attachment hardware 22.

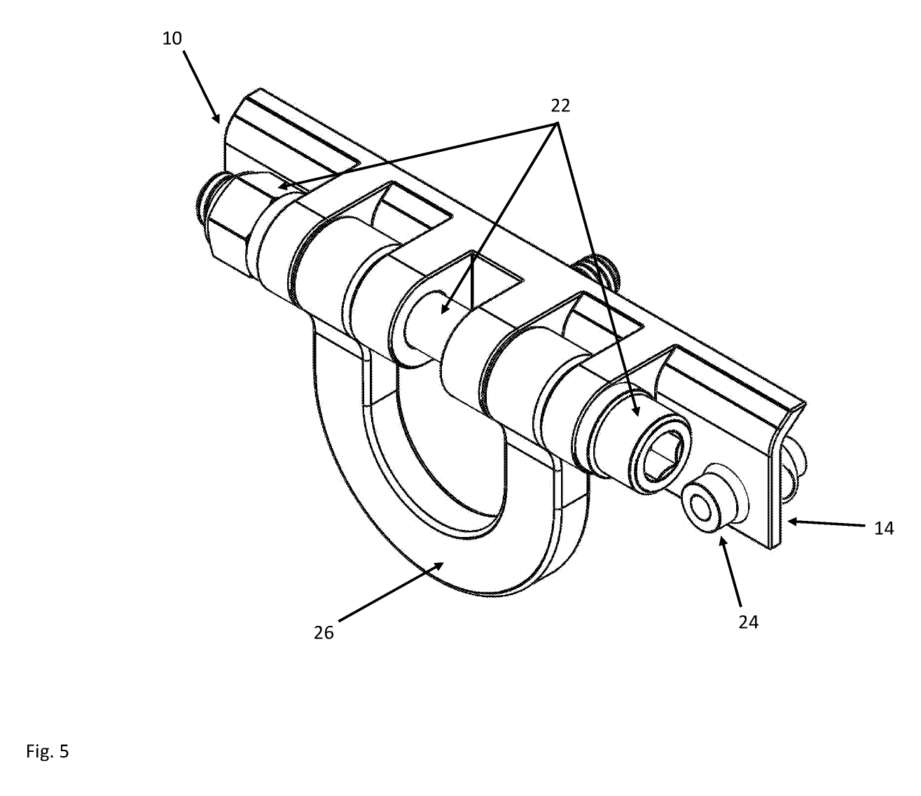

In more detail, referring to the invention of FIG. 5, tie-down ring 26 transfers a load into ring attachment hardware 22 which is secured through hole 16 (not shown) between protruding bosses 12 (see FIG. 4). Bracket attachment hardware 24 through face hole 18 is used to aid in securing bracket 10 mechanically to a perimeter rail behind face 14. Face 14 also aids in securing bracket 10 to a perimeter rail with the help of adhesives.

In further detail, still referring to the invention of FIG. 4 and FIG. 5, tie-down ring 26 is a continuous, solid piece of material which is approximately 2 inches tall and 2.25 inches wide. Ring attachment hardware 22 is approximately ⅜ inches in diameter and about 4 inches in length which is long enough to securely fit on protruding bosses 12. Bracket attachment hardware 24 may have a diameter ranging from approximately 0.2-0.4 inches and an in-grip depth ranging from 0.2-0.5 inches. Bracket 10 and its dimensions remain as described for FIG. 1-3.

Still referring to the invention shown in FIG. 4 and FIG. 5, construction details are provided. Tie-down ring 26 may be constructed of heat treated steel or any other sufficiently rigid and strong material such as composites, metals, or plastics. Tie-down ring 26 may be constructed in ways such as forging, machining, casting, 3D printing, or any other method in which a sufficiently strong tie-down ring 26 can be made. Ring attachment hardware 22 may consist of a nut and bolt, locking pin, or any other sufficiently strong and robust method of locking tie-down ring 26 between protruding bosses 12 while effectively transferring loads onto bracket 10. Similarly, bracket attachment hardware 24 may consist of bolts, rivets, or any other strong and robust method capable of securing bracket 10 to a perimeter rail as needed.

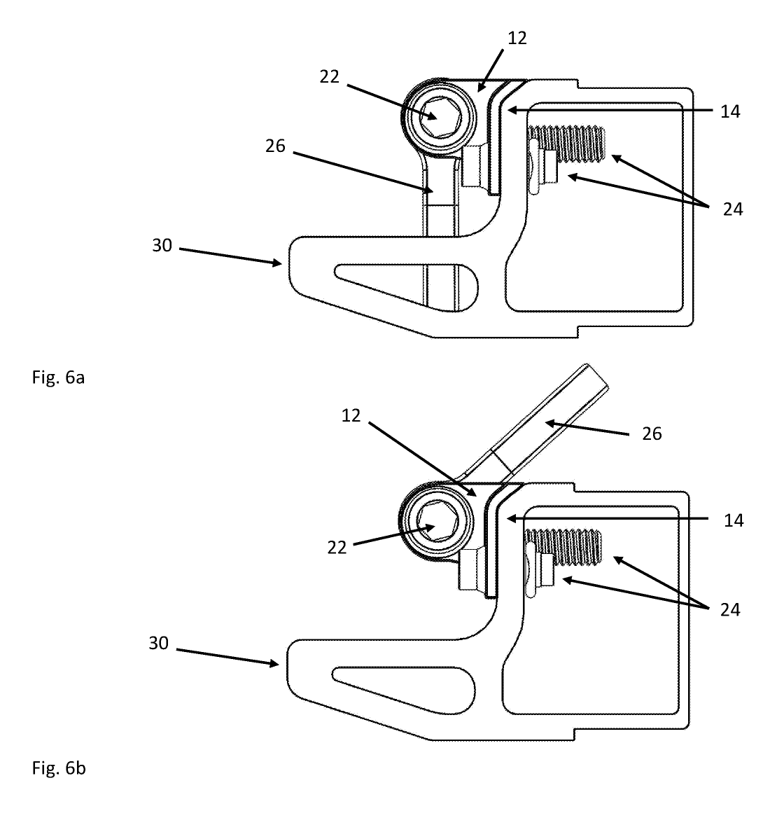

Referring now to the invention in FIG. 6a and FIG. 6b, bracket 10 containing protruding bosses 12 which hold ring attachment hardware 22 and tie-down ring 26 through holes 16 (not shown), is attached to perimeter rail 30 via bracket attachment hardware 24 through face holes 18 (not shown) in bracket 10. Additionally, adhesive is applied to face 14 on the back side of bracket 10 which contacts the face of perimeter rail 30 and further secures bracket 10 to perimeter rail 30.

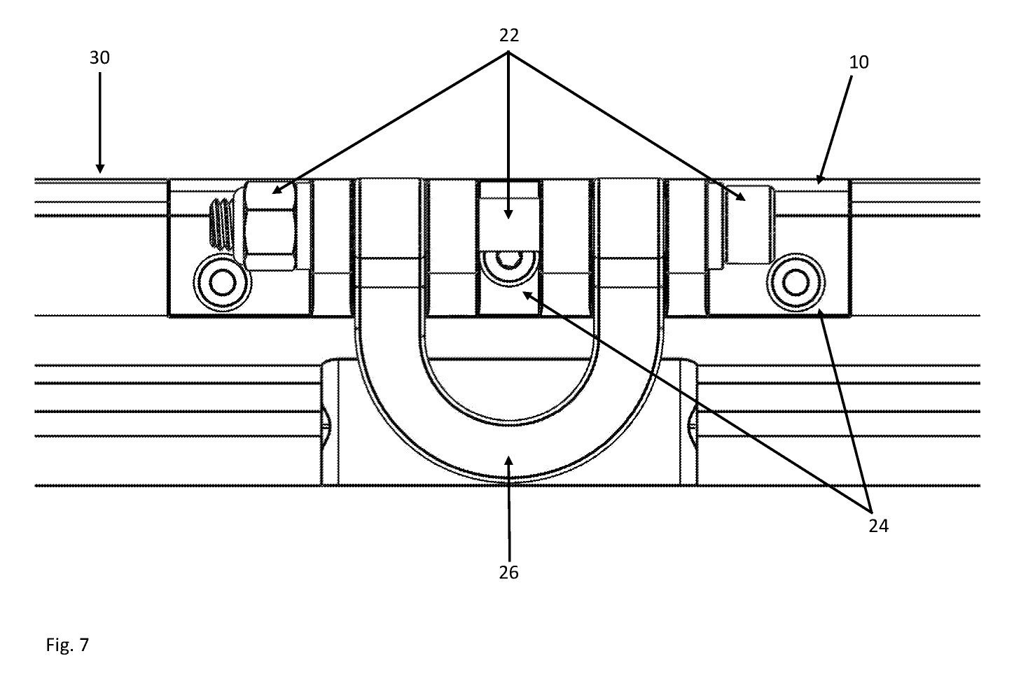

In more detail, referring to the invention of FIG. 7, the bracket attachment hardware 24 and adhesive applied on the back face 14 (not shown) of bracket 10 are used to transfer energy and serve as a load path for the load bearing tie-down ring 26 through ring attachment hardware 22 and into protruding bosses 12 of bracket 10 and ultimately into perimeter rail 30. Tie-down ring 26 rotates about ring attachment hardware 22 such that while not in use tie-down ring 26 hangs freely (FIG. 6a) and while being used (FIG. 6b) it's rotated upwards to engage with other devices.

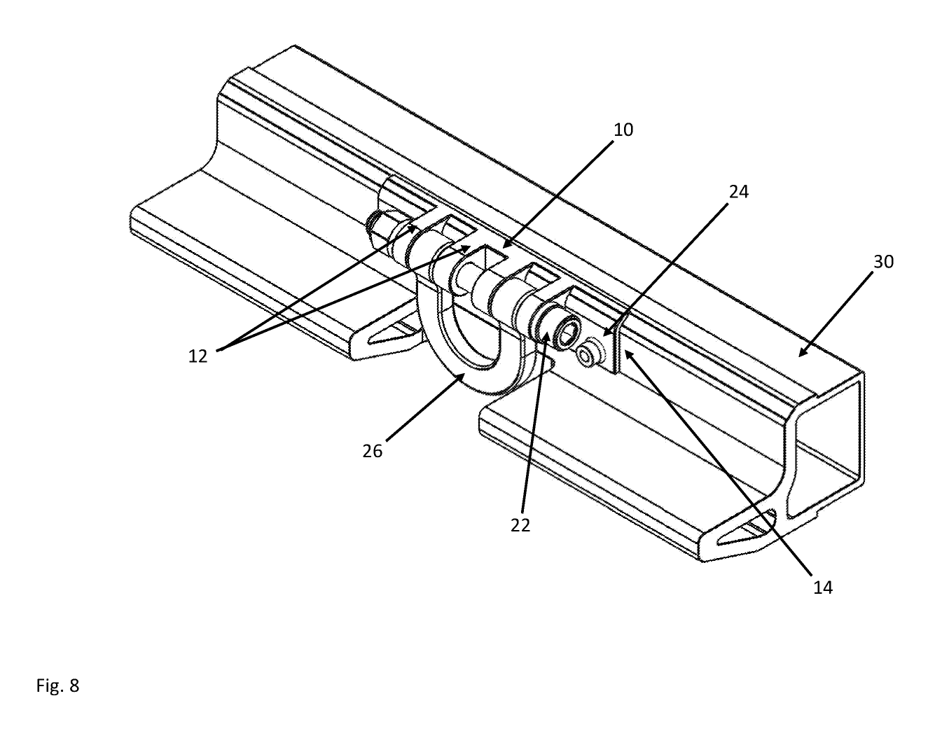

In further detail, referring to the invention of FIG. 8, perimeter rail 30 is sufficiently thick and strong, in the case of the 463L air cargo pallet perimeter rail by way of example only, having a cross section of approx. 2.5 inches tall, 1.7 inches wide at the location bracket 10 is attached, and a total of 3.5 inches wide from the back wall to the forward wall. Bracket 10 and tie-down ring 26 assembly, as seen in FIG. 4 and FIG. 5, carry the same dimensions as previously described but are now attached to perimeter rail 30 by bracket attachment hardware 24 and adhesive placed on face 14 of bracket 10.

Still referring to the invention as shown in FIG. 6a-8, construction details are provided. Perimeter rail 30 may be constructed of aluminum or any other sufficiently strong material such as composites, metals, plastics or others. Perimeter rail 30 may be constructed with methods such as extrusion, casting, 3D printing, or any other method in which a sufficiently strong component can be made. Bracket 10 and tie-down ring 26 assembly of FIG. 4 and FIG. 5 consist of the same materials and are attached to perimeter rail 30 with sufficiently strong adhesive on face 14 of bracket 10 and bracket attachment hardware 24 through face hole 18 of bracket 10.

### Results and Discussion

By way of example, the process of repair begins with removal of the originally damaged ring and bracket assembly on the 463L air cargo pallet rail. This is done by removing the three blind rivets attaching the bracket to the perimeter rail of the pallet. Once the old ring assembly has been cleared, the perimeter rail's surface should be primed by grinding/polishing the area of old paint and residue and suitably prepping the area for the new bracket assembly. Once clean, adhesive should be applied to the face of the bracket prior to securing the bracket to the perimeter rail via attachment hardware through the face holes of the bracket. Tie-down ring and attachment hardware may be installed through the holes of the protruding bosses as soon as the bracket is securely fixed to the perimeter rail.

Testing of the ring and bracket system known in the prior art (Legacy) shows that when the ring and bracket system is pulled with loads approximating 4,000-5,000 pounds the assembly may permanently deform, generating a damaged restraint system that will no long function at the required level, forcing the repair of the entire tie-ring and bracket assembly. The ring and bracket system of the present invention must perform at a level that demonstrates no deformation or permanent distortion of the ring or bracket at 7,500-pound load pulled in any direction. Additionally, with a safety factor of 1.5, the tie-down ring and bracket system of the present invention will withstand loads of more than 11,250 pounds while being pulled in any direction. Testing has shown that a ring made of 4140 steel, heat treated to 200 ksi held in the bosses of a 4140 steel bracket with a grade 8 bolt of 0.25-0.38 diameter will meet the design requirements.

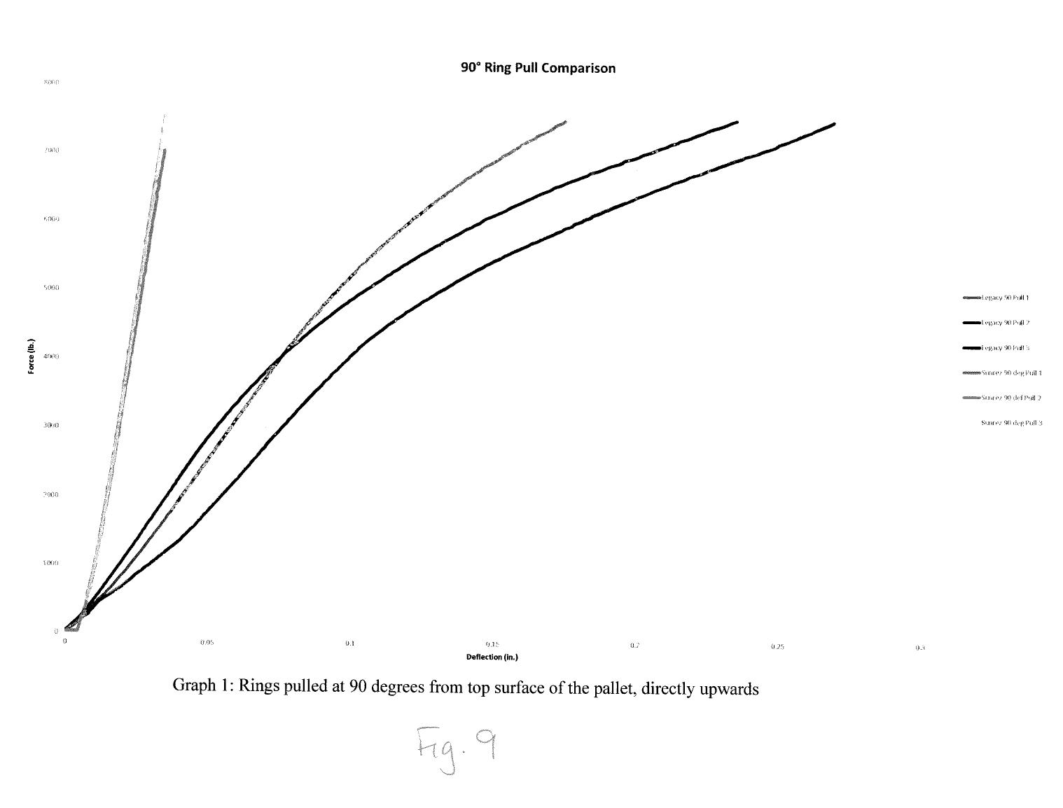

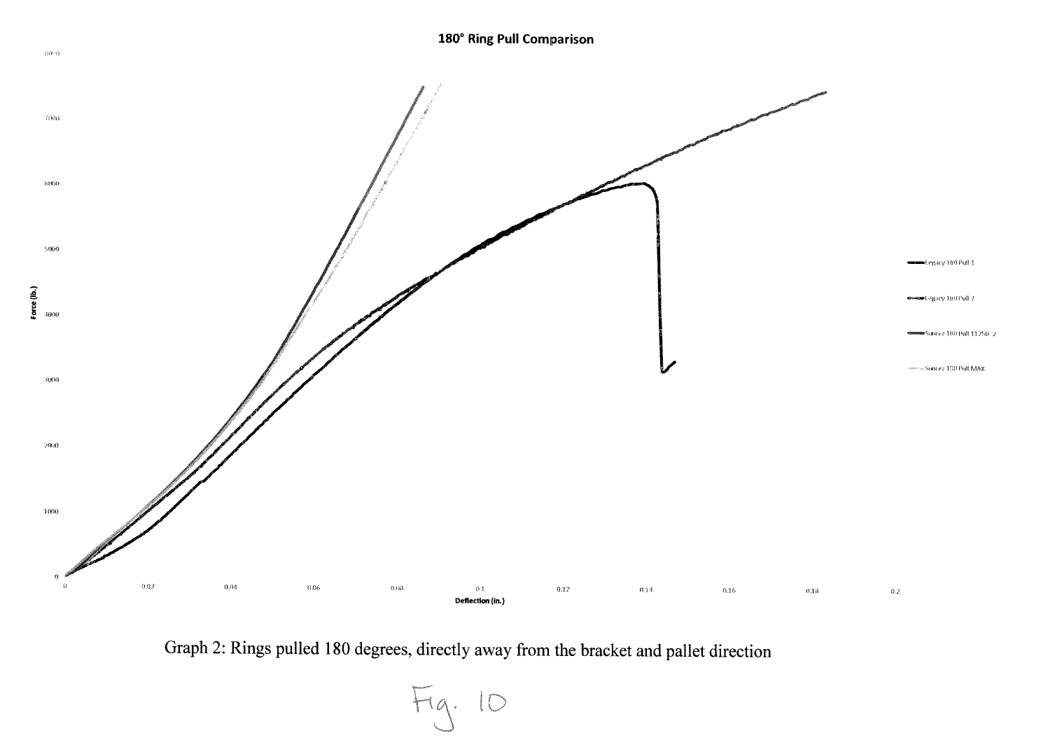

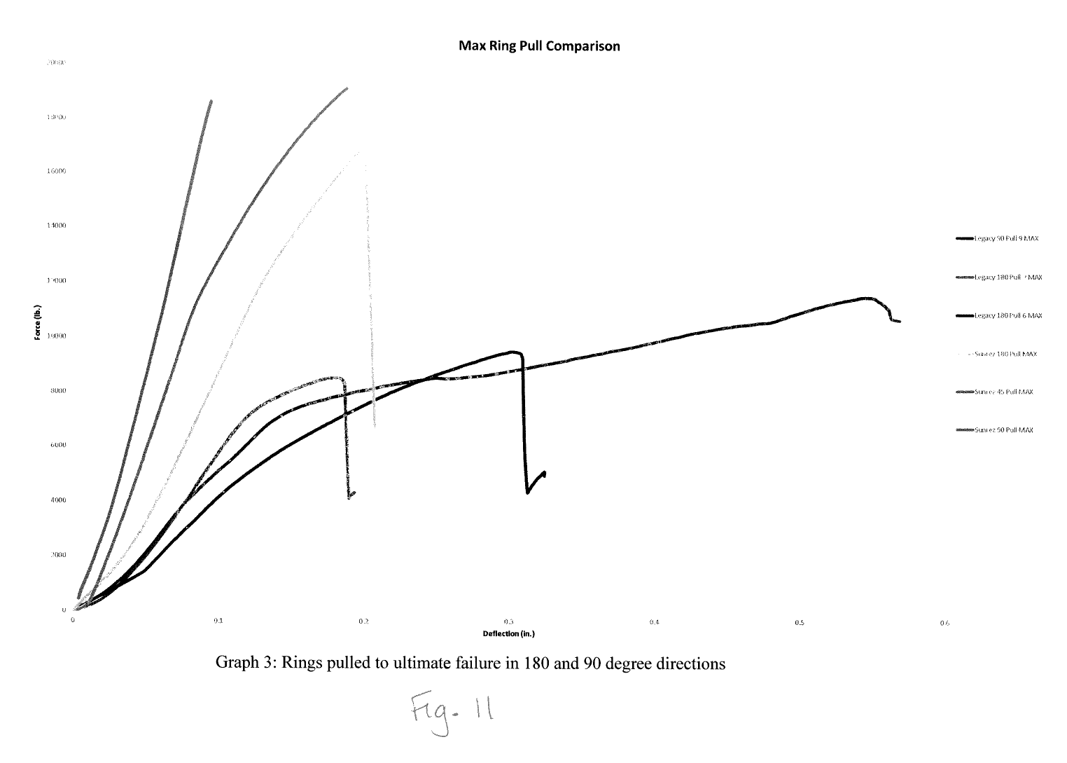

Briefly, FIG. 9-11 demonstrate the improved performance of the tie-down ring and bracket system of the present invention over the existing bracket system (Legacy) known in the part art. There are several tests used to measure the performance of the ring and bracket system as part of the 463L pallet assembly. The tests include pulling the ring to 7,500 pounds in several different directions, to replicate different tensioning methods used in the field. Additionally, weights ranging from 10,000 pounds to 18,000 pounds are fixed atop the pallet while the rings are engaged for various dynamic tests. These tests place the rings in very strenuous situations which can lead to deformation of the ring or bracket system, a violation of the test procedures. One of the critical tests performed replicates a crash landing and produces a sudden deceleration of a fully loaded pallet (10,000 lb). This test is performed multiple time to create a 3 g, 5 g, and 8 g incident, some of which have flexible nets restraining the cargo while some utilize tensioned chains. Instantaneous values obtained from a 3 g test with nets have been recorded at >6 g, a 5 g test with chains recorded at >10 g and an 8 g test with net recorded at over >16 g. The current system falls short in delivering the necessary performance in these very high, very short lived scenarios so a more robust system capable of transferring the load more effectively has been designed. The redesigned tie-down ring and bracket system of the present invention far exceeds the existing systems load capacity by addressing the weaknesses of the current system. In addition to being a more robust system, in the case of damage by misuse or negligence, the new system is easily repairable by removing the restraining pin/bolt and replacing the ring with a new component.

The advantages of the present invention include, without limitation, a more robust tie-down ring assembly containing a bracket which is mounted with mechanical fasteners and/or adhesive, as well as an easily removable tie-down ring.

One embodiment of the present invention provides a bracket and tie-down ring assembly which more effectively transfers a load through the bracket assembly.

A further embodiment of the present invention provides a bracket and tie-down ring assembly wherein the bracket is further comprised of a plurality of bosses integral to the bracket.

Still another embodiment of the present invention provides a bracket and tie-down ring assembly wherein the bosses protrude perpendicularly from the bracket.

Another embodiment of the present invention provides a bracket and tie-down ring assembly which exceeds all physical load requirements in the 463L material handling system.

Another embodiment of the present invention provides a bracket and tie-down ring assembly requiring fewer, less frequent repairs.

Still another embodiment of the present invention provides a bracket and tie-down assembly that is easy to remove and replace at the instance of damage without needing to remove the bracket.

In a broad embodiment, the present invention provides a new attachment method for a new tie-down ring and bracket assembly compatible with a perimeter rail of a 463L air cargo pallet.

Another embodiment of the present invention provides a method of restraining cargo, the method providing a cargo restraint assembly wherein the cargo restrain assembly comprises a load bearing bracket and a tie-down ring assembly, and further wherein the tie down ring assembly is capable of being altered to adapt different size brackets, tie-down rings, pins, mechanical fasteners, and adhesives for different load scenarios.

In yet another embodiment, the present invention provides a load bearing restraint assembly for truck beds, rail cars, cargo systems, boats, manufacturing plants, industry buildings, architecture, off road vehicles, military vehicles, emergency response vehicles, anything that warrants load bearing hardware being utilized to constrain a load through means of a tie-down ring.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A cargo restraint assembly for 463L cargo pallets, the assembly comprising:
a load bearing bracket; and
a tie-down ring assembly.

2. The assembly of claim 1 wherein the load bearing bracket of the cargo restraint assembly is further comprised of a plurality of protruding bosses.

3. The assembly of claim 2 wherein the plurality of protruding bosses extends perpendicularly from the load bearing bracket.

4. The assembly of claim 1 wherein the face of the bracket opposite the plurality of protruding bosses is curved.

5. The assembly of claim 2 wherein the bosses receive the tie-down ring assembly.

6. The assembly of claim 2 wherein tie-down ring assembly is further comprised of a tie-down ring and a pin wherein the tie down ring is inserted through a hole in each of the plurality of protruding bosses of the load bearing bracket.

7. The assembly of claim 6 wherein the pin rotates freely within the hole in each of the plurality of protruding bosses.

8. The assembly of claim 6 wherein the tie-down ring from the load bearing bracket is removable in the case of damage or repair.

9. The assembly of claim 2 wherein the bosses are integral to the load bearing perimeter rail for producing a superior load path for transferring forces from the tie-down ring, into the pin, and ultimately into the load bearing bracket via the protruding bosses.

10. The assembly of claim 7 wherein the pin rotates 360° within the hole of each of the plurality of protruding bosses.

11. The assembly of claim 7 wherein the ring rotates at least 225° within the hole of each of the plurality of protruding bosses.

12. The assembly of claim 2 wherein the load bearing bracket and the plurality of protruding bosses are manufactured as a single component.

13. The assembly of claim 1 wherein the tie-down ring assembly is capable of being pulled in any direction at 7,500 pounds without ultimate failure of it or the load bearing bracket

14. The cargo restraint system of claim 1 wherein the tie-down ring assembly is capable of being pulled in any direction by up to 11,250 pounds without ultimate failure of it or the load bearing brack.

15. The cargo restraint system of claim 1 wherein the tie-down ring assembly is capable of being pulled in any direction by up to 19,000 pounds without ultimate failure of it or the load bearing bracket.

16. A method of restraining cargo, the method providing a cargo restraint assembly wherein the cargo restrain assembly comprises a load bearing bracket and a tie-down ring assembly, and further wherein the tie down ring assembly is capable of being pulled in any direction by at least 7,500 pounds without ultimate failure.

17. A method of restraining cargo, the method providing a cargo restraint assembly wherein the cargo restrain assembly comprises a load bearing bracket and a tie-down ring assembly, and further wherein the tie down ring assembly is capable of being altered to adapt different size brackets, tie-down rings, pins, mechanical fasteners, and adhesives for different load scenarios.

18. A load bearing restraint assembly for truck beds, rail cars, cargo systems, boats, manufacturing plants, industry buildings, architecture, off road vehicles, military vehicles, emergency response vehicles, anything that warrants load bearing hardware being utilized to constrain a load through means of a tie-down ring.
